(19) United States
(12) Patent Application Publication
(10) Pub. No.: US 2020/0076201 A1
(43) Pub. Date: Mar. 5, 2020

(54) Island Grid And Method For Operating An Island Grid

(71) Applicant: Siemens Aktiengesellschaft, Munchen (DE)

(72) Inventors: Arvid Amthor, Grabfeld OT Nordheim (DE); Walter Hörmann, Gerasdorf bei Wien (AT); Markus Reischböck, Erlangen (DE)

(73) Assignee: Siemens Aktiengesellschaft, Munchen (DE)

(21) Appl. No.: 16/559,003

(22) Filed: Sep. 3, 2019

(30) Foreign Application Priority Data
Sep. 4, 2018 (EP) 18192475.4

(51) Int. Cl. H02J 3/46; H02J 3/38

(52) U.S. Cl. CPC H02J 3/46; H02J 2003/388; H02J 3/381

(57) ABSTRACT

Various embodiments include an island grid comprising: a power generator for generating an electric power; a controller for moderating an amount of electric power generated by the power generating unit; and a grid connection point to a superordinate electric grid. The controller operates the island grid in a first operating state decoupled from the electrical grid. The controller operates the island grid in a second operating state coupled to the electrical grid at the grid connection point. The control unit uses a separate controlled variable for each of the two operating states.

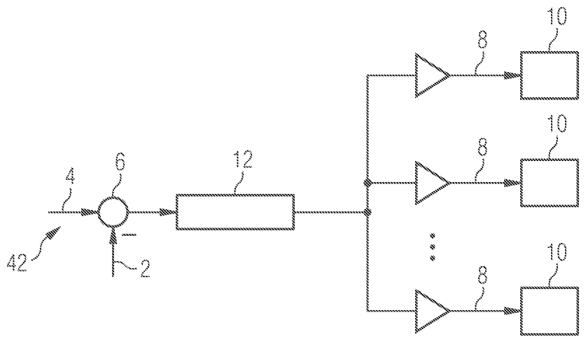

### CROSS-REFERENCE TO RELATED APPLICATIONS

This application claims priority to EP Application No. 18192475.4 filed Sep. 4, 2018, the contents of which are hereby incorporated by reference in their entirety.

### TECHNICAL FIELD

The present disclosure relates to electric power distribution. Various embodiments may include island grids and/or methods for operating an island grid.

### BACKGROUND

Island grids, with regard to electric power, are supply areas that can be operated independently of an electric grid that is superordinate with respect to the island grid, for example an interconnected grid. Island grids are used in geographically remote regions, in particular. In this case, coupling the island grid to a superordinate electrical grid via a grid connection point may be technically and/or economically impractical. Furthermore, ships, drilling rigs, and the like are functionally island grids. The latter can be referred to as permanent island grids and are able, for example on account of diesel generators, to cover the entire electrical load within the island grid.

Island grids are used in regions with a superordinate electric grid or interconnected grid for short-term provision of an electric power (emergency power), particularly in safety-relevant environments. In this case, they ensure the supply for a specific, typically short-term, period of time or support initiation of an emergency program, typically likewise by means of diesel generators. However, these island grids are not permanent, that is to say that they are not suitable for maintaining a permanent island operation mode or island state. Such non-permanent island grids can accordingly be operated independently of the superordinate electrical grid only to a limited extent, since otherwise there is the risk of a supply interruption (blackout) within the island grid. In other words, non-permanent island grids must typically be coupled to and decoupled from a superordinate electric grid as often as needed. A supply interruption within the island grid must not occur in this case.

### SUMMARY

The teachings of the present disclosure include island grids and methods for operating an island grid so as to enable improved coupling to and decoupling from an electrical grid that is superordinate with respect to the island grid. For example, some embodiments include an island grid, comprising at least one or a plurality of power generating units (10) for generating an electrical power, a control unit (12) for controlling each of the electrical powers generated by means of the power generating units (10), and a grid connection point to an electrical grid that is superordinate with respect to the island grid, wherein the island grid is operable in a first operating state decoupled from the electrical grid and in a second operating state coupled to the electrical grid by means of the grid connection point, characterized in that the control unit (12) is configured to define the controlled variable (42) provided for control depending on the two operating states.

In some embodiments, the controlled variable (42) in the first operating state is the frequency of the island grid.

In some embodiments, the controlled variable (42) in the second operating state is an active power and/or reactive power of the power generating units at the grid connection point.

In some embodiments, the island grid comprises at least one combined heat and power plant, at least one diesel generator, at least one photovoltaic installation, at least one wind power installation and/or at least one energy store as power generating units.

In some embodiments, the island grid is configured as an intelligent electrical grid, wherein an intelligent control device of the intelligent electrical grid comprises the control unit.

As another example, some embodiments include a method for operating an island grid comprising one or a plurality of power generating units (10), a control unit (12) and a grid connection point to an electrical grid that is superordinate with respect to the island grid, wherein the island grid is operated in a first operating state decoupled from the electrical grid or in a second operating state coupled to the electrical grid by means of the grid connection point, and wherein each of the electrical powers generated by means of the power generating units (10) is controlled by means of a controlled variable (42) of the control unit (12), characterized in that the controlled variable (42) is defined depending on the operating states of the island grid.

In some embodiments, the frequency of the island grid is defined as the controlled variable (42) for the first operating state.

In some embodiments, an active power and/or a reactive power of the power generating units at the grid connection point is defined as the controlled variable (42) for the second operating state.

In some embodiments, the island grid changes between the first and second operating states.

### BRIEF DESCRIPTION OF THE DRAWINGS

Further advantages, features, and details of the teachings herein become apparent in relation to the exemplary embodiment described below and with reference to the drawing. In this case, the single FIGURE shows schematic control of an island grid incorporating teachings of the present disclosure. The FIGURE schematically shows the control of the island grid for an island operation mode (first operating state) and a grid operation mode (second operating state).

### DETAILED DESCRIPTION

Some embodiments of an island grid incorporating teachings of the present disclosure comprise at least one or a plurality of power generating units for generating an electrical power, a control unit for controlling each of the electrical powers generated by means of the power generating units, and a grid connection point to an electrical grid that is superordinate with respect to the island grid, wherein the island grid is operable in a first operating state decoupled from the electrical grid and in a second operating state coupled to the electrical grid by means of the grid connection point. The control unit is configured to define the controlled variable provided for control depending on the two operating states. The first operating state is referred to as island operation mode. The second operating state is referred to as grid operation mode.

In some embodiments, the island grid comprises the control unit, which makes it possible to define the controlled variable depending on the island operation mode (first operating state) and on the grid operation mode (second operating state). In the island operation mode, the island grid is decoupled from the superordinate electrical grid. In the grid operation mode, the island grid is coupled to the superordinate electrical grid. In other words, a controlled variable different than that for the grid operation mode is used for the island operation mode.

In some embodiments, a first physical variable is used as the controlled variable in the island operation mode and a second physical variable is used as the controlled variable in the grid operation mode. Two different types of control with respect to the island operation mode and the grid operation mode are possible as a result. A change between the island operation mode and the grid operation mode without interruptions in the power supply within the island grid becomes possible as a result.

In some embodiments, in the island operation mode, a frequency stability of the island grid is typically important, while in the grid operation mode the electrical powers of the power providing units are only made available to the superordinate electrical grid. The grid stability of the superordinate electrical grid is typically ensured by units of the superordinate electrical grid, for example central large generators such as power plants. In some embodiments, it is thus possible to operate the island grid as stably as possible in the island operation mode and in the grid operation mode and thus to decouple said island grid from the superordinate electrical grid as stably as possible and to couple it to the superordinate electrical grid as stably as possible.

The respective electrical power of the power generating units is controlled by open-loop and/or closed-loop control by means of the controlled variable. In other words, the controlled variable has a setpoint value and an actual value. As a result, each of the power generating units has a setpoint power and an actual power. The actual value of the controlled variable can be a present value of the controlled variable, which is detected or measured by means of a detection unit. If there is a difference between the setpoint value and the actual value of the controlled variable, then the electrical power of at least one of the power generating units is altered or adapted. This can be done until said difference decreases in magnitude or is zero.

In some embodiments, a method for operating an island grid comprising one or a plurality of power generating units, a control unit and a grid connection point to an electrical grid that is superordinate with respect to the island grid, the island grid is operated in a first operating state decoupled from the electrical grid or in a second operating state coupled to the electrical grid by means of the grid connection point, and each of the electrical powers generated by means of the power generating units is controlled by means of a controlled variable of the control unit.

In some embodiments, the controlled variable is defined depending on the operating states of the island grid. Advantages of the methods described herein are of the same kind as those for the island grid incorporating the teachings herein are afforded.

In some embodiments, the controlled variable in the first operating state is the frequency of the island grid. This may ensure the frequency stability of the island grid in the island operation mode. In other words, the frequency stability in the island operation mode is ensured by all the power generating units, without there being for example one dominant power generator that ensures the frequency stability and thus the stability of the island grid by itself. In other words, in the island operation mode, the frequency stability and thus the stability of the island grid are ensured by the power generating units jointly. In some embodiments, individual power generating units of the island grid can be operated or not operated, without jeopardizing the frequency stability. The power of the power generating units is controlled by open-loop or closed-loop control depending on the frequency or depending on a difference between a setpoint frequency and an actual frequency of the island grid by means of the control unit (primary control). Furthermore, the total load required within the island grid by power consumption units can be shared without any surges, that is to say with no impairment of the frequency stability, as desired among the power generating units by means of the control unit. This can be done during the island operation mode of the island grid. Furthermore, the island grid can be disconnected from the superordinate electrical grid (change from the grid operation mode to the island operation mode), without impairing the frequency stability of the island grid in the island operation mode.

In some embodiments, the controlled variable in the second operating state is an active power and/or a reactive power of the power generating units at the grid connection point. As a result, the coupling and decoupling of the island grid to and from the superordinate electrical grid, that is to say a change between the two operating states of the island grid, can take place without any surges. The active power and/or reactive power is made available to the superordinate electrical grid by means of the grid connection point.

Some embodiments use the frequency of the island grid as the controlled variable of the island operation mode and the active power and/or reactive power at the grid connection point as the controlled variable of the grid operation mode. In other words, in the island operation mode a first controlled variable, the frequency of the island grid, and in the grid operation mode a second controlled variable different than the first controlled variable, the active power and/or reactive power at the grid connection point, are used for the control of the powers of the power providing units by the control unit.

In some embodiments, the island grid comprises at least one combined heat and power plant, at least one diesel generator, at least one photovoltaic installation, at least one wind power installation and/or at least one energy store as power generating units. By way of example, the island grid comprises a combination of the power generating units mentioned. In particular, inverter-based power generating units, for example photovoltaic installations and/or battery stores, can be concomitantly encompassed by the control. Within the meaning of the present invention, energy stores, in particular electrochemical energy stores, for example battery stores, are regarded as power generating units.

In some embodiments, the island grid is configured as an intelligent electrical grid, wherein an intelligent control device of the intelligent electrical grid comprises the control unit. In other words, the island grid forms a smart grid. In this case, the control can be implemented by means of real-time control hardware, for example PLC.

As shown in the FIGURE, the example island grid comprises a control unit 12 and a plurality of power providing units 10. As can be discerned from the FIGURE, the controls or the control structure for the two operating states are or is substantially identical. They differ principally in a controlled variable 42 used for the control.

For the island operation mode, the frequency of the island grid is provided as the controlled variable 42. Consequently, the frequency of the island grid is defined or used as the controlled variable 42 for the island operation mode by means of the control unit 12. For the grid operation mode, an active power and/or reactive power at a grid connection point of the island grid is used or defined as the controlled variable 42 for control by means of the control unit 12.

The controlled variable 42 has in each case a setpoint value 4 and an actual value 2. The control of the electrical powers of the power providing units 10 is effected on the basis of the difference 6 between the setpoint value 4 and the actual value, said difference being used in the control by means of the control unit 12. For this purpose, depending on said difference between the setpoint value 4 and the actual value 2, the control unit 12 prescribes a setpoint power 8 for each of the power providing units 10. In the FIGURE, a total power is thus shared among the individual power providing units 10 by means of the control unit 12. This sharing is illustrated symbolically by the branching and the triangles. The sharing can be effected by means of a function that is referred to in English as load sharing.

Consequently, there is no difference in the basic scheme of the control of the island grid for an island operation mode and a grid operation mode. In some embodiments, however, the controlled variable 42 used for control is adapted to the two operating states. In other words, a change in the operating states is likewise accompanied by a change in the controlled variable 42. A surge-free and failure-free change of the island grid between the two operating states is made possible as a result.

Although the teachings herein are more specifically illustrated and described in detail by means of the exemplary embodiments, nevertheless the scope of the teaching is not restricted by the examples disclosed or other variations can be derived therefrom by the person skilled in the art, without departing from the scope.

### LIST OF REFERENCE SIGNS

2 Actual value
4 Setpoint value
6 Difference
8 Setpoint power
Power generating unit
12 Control unit
42 Controlled variable

1. An island grid comprising:
a power generator for generating an electric power;
a controller for moderating an amount of electric power generated by the power generating unit; and
a grid connection point to a superordinate electric grid;
wherein the controller operates the island grid in a first operating state decoupled from the electrical grid; and
the controller operates the island grid in a second operating state coupled to the electrical grid at the grid connection point;
wherein the control unit uses a separate controlled variable for each of the two operating states.

2. The island grid as claimed in claim 1, wherein the controlled variable for the first operating state is a frequency of the island grid.

3. The island grid as claimed in claim 1, wherein the controlled variable in the second operating state is an active power and/or reactive power of the power generating unit at the grid connection point.

4. The island grid as claimed in claim 1, wherein the power generating unit comprises at least one unit selected from the group consisting of:
a combined heat and power plant;
a diesel generator;
a photovoltaic installation;
a wind power installation; and
an energy store.

5. The island grid as claimed in claim 1, wherein:
the island grid comprises an intelligent electrical grid; and
the control unit comprises an intelligent control device.

6. A method for operating an island grid, wherein the island grid comprises a power generator, a control unit, and a grid connection point to superordinate electrical grid, the method comprising:
operating the island grid in a first operating state decoupled from the electrical grid;
operating the island grid in a second operating state coupled to the electrical grid at the grid connection point;
wherein an electrical power generated by the power generator is controlled based at least in part on a controlled variable by the control unit;
wherein the controlled variable is defined depending on the operating state of the island grid.

7. The method as claimed in claim 6, wherein the controlled variable of the first operating state includes a frequency of the island grid.

8. The method as claimed in claim 6, wherein the controlled variable of the second operating state includes an active power and/or a reactive power of the power generator at the grid connection point.

9. The method as claimed in claim 6, further comprising changing the island grid between the first and second operating states.
